(19) United States
(12) Patent Application Publication
(10) Pub. No.: US 2009/0191762 A1
(43) Pub. Date: Jul. 30, 2009

(54) Card Connector

(76) Inventor: Katsumi Yamaguchi, Saitama (JP)

Correspondence Address: BARLEY SNYDER, LLC, 1000 WESTLAKES DRIVE, SUITE 275, BERWYN, PA, 19312, US

(21) Appl. No.: 12/360,642

(22) Filed: Jan. 27, 2009

(30) Foreign Application Priority Data
Jan. 30, 2008 (JP) 2008-019566

(51) Int. Cl. H01R 24/00; H01R 13/62

(52) U.S. Cl. 439/631; 439/159

(57) ABSTRACT

It is an object of the present invention to provide a card connector which prevents inadvertent dropping of a card having a narrow width relative to the receiving slot to be inserted. The card connector includes receiving slots that are stacked and receive a plurality of memory cards of different standards. The card connector minimizes the height so as to be replaceable with a conventional card connector. The card connector has a first card receiving slot that receives a first card and a second card receiving slot that accommodates a second card receiving unit. The second card receiving unit receives a second card. The second card receiving unit has a top frame that restricts the upper surface of a second card main body. A cutout part, having a shape that allows at least a portion of the top frame to fit in the thickness direction, is formed in a partition frame. The partition frame divides the first card receiving slot and the second card receiving, while supporting the lower portion of a first card main body.

### CROSS-REFERENCE TO RELATED APPLICATIONS

This application claims the benefit of the filing date under 35 U.S.C. §119(a)-(d) of Japanese Patent Application No. 2008-019566, filed Jan. 30, 2008.

### FIELD OF THE INVENTION

The present invention relates to a card connector, and particularly to a composite-type card connector, which can receive a plurality of card types with different standards.

### BACKGROUND

PC cards compliant with the PCMCIA standards, so-called express cards compliant with the PCMCIA standards (hereinafter referred to as “express cards”), SD (memory) cards, and the like have been used in the past as memory cards or card-type hardware interfaces used in information devices such as computers.

A composite-type card connector having a plurality of stacked card receiving slots to receive a plurality of card types with different standards is well known. A composite-type card connector that can receive a PC card and an express card, such as that shown in FIGS. 8A and 8B (see JP2006-190612A), for example, is well known, as a composite-type card connector in which a plurality of card receiving slots are stacked.

FIGS. 8A and 8B show a conventional composite-type card connector that receives an express card and a PC card (not shown in the figures); FIG. 8A is a front view, and FIG. 8B is a sectional view along line 8B-8B in FIG. 8A.

The card connector 101 shown in FIGS. 8A and 8B is formed by stacking a first card connector device 102 and a second card connector device 103.

The first card connector device 102 has an insulating first housing 110, a plurality of contacts 120 attached to the first housing 110, and a first card receiving slot 130 that receives and guides an express card C1.

Furthermore, the second card connector device 103 has an insulating second housing 140 provided underneath the first housing 110, a plurality of contacts 150 attached to the second housing 140, and a second card receiving slot 160 that guides a PC card (not shown in the figures).

The first card receiving slot 130 includes a top frame 131, a right side plate part 132, a left side plate part 133, and a bottom frame 134. The top frame 131 and bottom frame 134 are plate-form bodies that are attached to the first housing 110, and extend in the direction of removal of the express card C1 (hereinafter referred to as “rearward”). The top frame 131, right side plate part 132, and left side plate part 133 are formed as an integral unit, by bending downward both the right and left end portions of a single metal plate. Such integral formation not only reduces working man-hours and increases productivity, but also makes it possible to maintain the strength of the top frame 131, right side plate part 132, and left side plate part 133 at a high level. The lower end portions of the right side plate part 132 and left side plate part 133 are connected to the bottom frame 134, which supports the undersurface of the express card C1 upon insertion of the express card C1 into the first card receiving slot 130 until the removal of this card.

The second card receiving slot 160 includes a top frame 161, a right side plate part 162, a left side plate part 163, and a bottom frame 164. The top frame 161 and bottom frame 164 are plate-form bodies that are attached to the second housing 140 and that extend rearward. The top frame 161, right side plate part 162, and left side plate part 163 are formed as an integral unit by bending downward both the right and left end portions of a single metal plate. The lower end portions of the right side plate part 162 and left side plate part 163 are connected to the bottom frame 164. The bottom frame 164, right side plate part 162, and left side plate part 163 respectively support the undersurface and both side surfaces of the PC card C1 upon insertion of this PC card C1 into the second card receiving slot 160 until the removal of this card C1.

Here, there are two types of express cards C1 having different width dimensions (dimension in the direction perpendicular to the insertion-and-removal direction and stacking direction).

FIGS. 9A and 9B show one of the two types of express cards C1 inserted into and removed from the first card receiving slot 130; FIG. 9A is a perspective view as seen from the side of the front surface, and FIG. 9B is a perspective view as seen from the side of the back surface. Furthermore, FIGS. 10A and 10B show the other of the two types of express card C1 inserted into and removed from the first card receiving slot 130; FIG. 10A is a perspective view as seen from the side of the front surface, and FIG. 10B is a perspective view as seen from the side of the back surface.

The express cards C1 include a card having a wide width (a width of 54 mm; hereinafter referred to as “express card C1w”) and a card formed with a narrow width (a width of 34 mm; hereinafter referred to as “express card C1n”).

As is shown in FIGS. 9A and 9B, the express card C1w is formed in a shape having a right shoulder part which is formed by cutting out the right side portion on the side of the insertion of a card main body C1a formed in a wide flat plate form (a width of 54 mm).

The express card C1n is formed with a narrow width (a width of 34 mm) in a shape in which both sides are straight as shown in FIGS. 10A and 10B.

As was described above, because there are two types of express cards C1 with different width dimensions, it is necessary to form the bottom frame 134 in a shape that supports the entire bottom portion (back surface) of the wide express card C1 in a planar manner. The reason for this is as follows: namely, in cases where the express card C1n is received in the first card receiving slot 130, the width dimension is insufficient relative to the first card receiving slot 130, so that the express card C1n cannot be supported by the right side plate part 132, creating the problem of this card falling down.

Meanwhile, the card connector shown in FIGS. 11A and 11B, for instance, has been known in the past as a composite-type card connector that can receive a PC card and a plurality of types of memory card.

FIGS. 11A and 11B show a conventional composite-type card connector that receives a PC card and a memory card (second card) of any of a plurality of types; FIG. 11A is a front view, and FIG. 11B is a sectional view along line 11B-11B in FIG. 11A.

Furthermore, FIGS. 12A and 12B show an example of a memory card (second card) of any of a plurality of types; FIG. 12A is a plan view, and FIG. 12B is a back view.

The card connector 201 shown in FIGS. 11A and 11B is formed by stacking a first card connector device 202 and a second card connector device 203.

The first card connector device 202 has an insulating first housing 210, a plurality of contacts 220 attached to the first housing 210, and a first card receiving slot 230 that guides a PC card (not shown in the figures).

Furthermore, the second card connector device 203 includes an insulating second housing 240 provided underneath the first housing 210, a plurality of contacts (not shown in the figures) attached to the second housing 240, and a second card receiving slot 270 that guides a second card receiving unit 260.

The first card receiving slot 230 is formed from a top frame 231, a right side plate part 232, a left side plate part 233, and a bottom frame 234. The top frame 231 and bottom frame 234 are plate-form bodies that are attached to the first housing 210 and that extend rearward. The top frame 231, right side plate part 232, and left side plate part 233 are formed as an integral unit by bending downward both the right and left end portions of a single metal plate. The lower end portions of the right side plate part 232 and left side plate part 233 are linked to the bottom frame 234. The bottom frame 234, right side plate part 232, and left side plate part 233 respectively support the undersurface and both side surfaces of the PC card C1 upon insertion of this PC card C1 into the first card receiving slot 230 until the removal of this card.

The second card receiving slot 270 is formed from a top frame 271, a right side plate part 272, a left side plate part 273, and a bottom frame 274. The top frame 271 and bottom frame 274 are plate-form bodies that are attached to the second housing 240 and that extend rearward. The top frame 271, right side plate part 272, and left side plate part 273 are formed as an integral unit by bending downward both the right and left end portions of a single metal plate. The lower end portions of the right side plate part 272 and left side plate part 273 are linked to the bottom frame 274. Moreover, a pair of projecting parts 275 and 276, which face each other at a specified distance in the direction of width of the second card receiving slot 270, are formed on the inner wall surfaces of the right side plate part 272 and left side plate part 273, respectively. The second card receiving unit 260 is inserted into and removed from the second card receiving slot 270, with the end portions on both sides of the circuit board (described later) thereof being held between the projecting parts 275 and 276, as well as the bottom frame 274.

The second card receiving unit 260 has a circuit board 262 and a connector 263 (hereinafter referred to as “third card connector device”) that is mounted on this circuit board 262, capable of receiving a second card. The third card connector device 263 has a housing 261, a plurality of contacts 262a, 262b, and 262c, and a top frame 264. Furthermore, the third card connector device 263 has an opening part (second card insertion slot) 263a into which the memory card (second card C2) of any of a plurality of card types is inserted. Moreover, the third card connector device 263 has side frames 265 and 266 that are formed integrally by bending downward both the right and left end portions of the top frame 264. The top frame 264 and side frames 265 and 266 are formed as an integral unit by bending downward both the right and left end portions of a single metal plate. The contacts 262a, 262b, and 262c are provided to face a plurality of card contact points C2b (see FIG. 12B), which are provided in the vicinity of the end portion on the side of the back surface of the second card C2 in accordance with the standards of the second card C2 inserted from the opening part 263a. Then, when the second card C2 is inserted into the opening part 263a, the card contact points C2b of the second card C2 are pressed by either the contacts 262a, 262b, or 262c with the respective elastic forces of the contacts, thus obtaining an electrical connection between these contacts 262a, 262b, or 262c and the card contact points C2b.

Thus, because the second card C2 is pushed upward by either the contacts 262a, 262b, or 262c when the second card C2 is received in the third card connector device 263, the second card receiving unit 260 has a top frame 264 that restricts the upper surface of the second card C2.

Here, it is desirable that such a composite-type card connector, which receives a plurality of card types, allows selection of a combination of card connector devices according to the medium based on the requests of the consumer and be replaceable in the housing of an information device or the like to be installed. Therefore, a housing that can accommodate a composite-type card connector is provided with an accommodation area (bay) that is standardized to accommodate a composite-type card connector combining various types of card connector devices. In concrete terms, as is shown in FIGS. 8A and 11A, a composite-type card connector is designed such that the dimension h1 from the upper surface of a motherboard M inside a housing where this card connector is to be installed to the upper surface of the uppermost card connector device of the composite-type card connector falls within a specified dimension range when the composite-type card connector is installed on this motherboard M.

However, in cases where a composite-type card connector in which the receiving slot 130 shown in FIGS. 8A and 8B and the receiving slot 270 shown in FIGS. 11A and 11B are stacked is requested by the consumer, it has been difficult to manufacture a composite-type card connector that combines these receiving slots with the height of the bay described above.

The cause of this is thought to be that the height dimension h2 of the receiving slot 130 or the height dimension h2 of the receiving slot 270 is greater than the height dimension h3 of the receiving slot 160 (230). Note that the height dimension h2 of the receiving slot 130 is the distance between the upper surface of the top frame 131 and the undersurface of the bottom frame 134. The height dimension h2 of the receiving slot 270 is the distance between the upper surface of the top frame 271 and the undersurface of the bottom frame 274. The height dimension h3 of the receiving slot 160 (230) is the distance between the upper surface of the top frame 161 (231) and the undersurface of the bottom frame 164 (234).

Furthermore, the difference between the height dimension (h1) of a conventional bay and the height dimension (h2+h2) in the case of manufacturing a card connector in which the receiving slot 130 and the receiving slot 270 are stacked is approximately the thickness of a single frame.

That is, the height dimension of the composite-type card connector of such a combination is thought to be greater than that of a conventional composite-type card connector as a result of the bottom frame 134 and top frame 271 being superimposed.

For example, the thickness of the bottom frame 134 is approximately 0.25 mm, and the thickness of the top frame 271 is approximately 0.2 mm. That is, in cases where the receiving slot 130 and the receiving slot 270 are simply stacked one on the other, the thickness that must be suppressed to approximately 0.3 mm ends up being 0.45 mm because of the superimposition of the bottom frame 134 and top frame 271. As a result, when a card connector of such a combination is installed on a motherboard M, inside a housing constituting the object of installation, the dimension from the upper surface of this motherboard M to the upper surface of the stacked upper receiving slot exceeds the dimension h1 (h1=h2+h3). Therefore, it has been difficult to provide a card connector that is replaceable in the bay having the same standards as in the prior art.

### SUMMARY

Accordingly, the present invention was devised in light of the problems described above; it is an object of the present invention to provide a card connector which prevents inadvertent dropping of a card having a narrow width relative to the receiving slot to be inserted, which allows stacking of receiving slots that receive a plurality of card types of different standards, and which has the same standards as conventional card connectors, especially suppressed to a height that is equal to or lower than the height of conventional card connectors.

In order to solve the problems described above, the card connector of claim 1 is a card connector that includes stacked receiving slots that receive a plurality of memory cards of different standards. The card connector minimizes the height so as to be replaceable with a conventional card connector. The card connector has a first card receiving slot that receives a first card and a second card receiving slot that accommodates a second card receiving unit. The second card receiving unit receives a second card. The second card receiving unit has a top frame that restricts the upper surface of a second card main body. A cutout part, having a shape that allows at least a portion of the top frame to fit in the thickness direction, is formed in a partition frame. The partition frame divides the first card receiving slot and the second card receiving, while supporting the lower portion of a first card main body.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B show a card connector according to the present invention, with FIG. 1A being a plan view, and FIG. 1B being a front view;

FIGS. 2A and 2B show the card connector of FIG. 1, with FIG. 2A being a right side view, and FIG. 2B being a left side view;

FIG. 3 is a bottom view of the card connector of FIGS. 1A and 1B;

FIGS. 4A and 4B are the diagrams showing the construction of the partition frame, with FIG. 4A being a sectional view along line 4-4 in FIG. 1B, and FIG. 4B being a plan view of the partition frame;

FIG. 5 is a sectional view along line 5-5 in FIG. 1B;

FIGS. 6A and 6B show the second card receiving unit, with FIG. 6A being a top view of the second card receiving unit, and FIG. 6B being a sectional view of the second card receiving unit;

FIGS. 7A and 7B show the essential parts of the card connector of the present invention, with FIG. 7A being a sectional view showing the positional relationship between the partition frame and top frame in FIG. 1B, and FIG. 7B being a sectional view showing the function of the inclined part during the insertion of the first card in FIG. 5;

FIGS. 8A and 8B show the conventional card connector that receives a first card (express card) and a PC card, with FIG. 8A being a front view, and FIG. 8B being a sectional view;

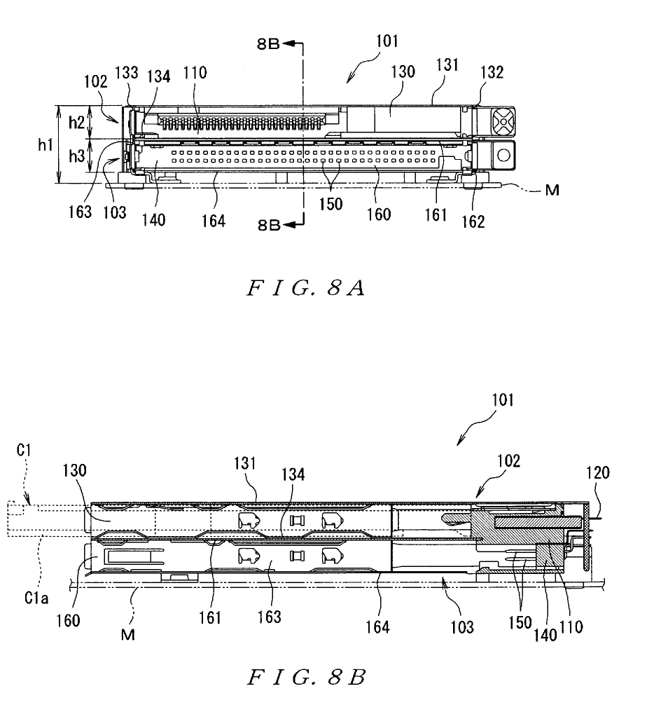

FIGS. 9A and 9B show one example of a first card (express card) that is inserted into and removed from the first card receiving slot, with FIG. 9A being a perspective view as seen from the side of the front surface, and FIG. 9B being a perspective view as seen from the side of the back surface;

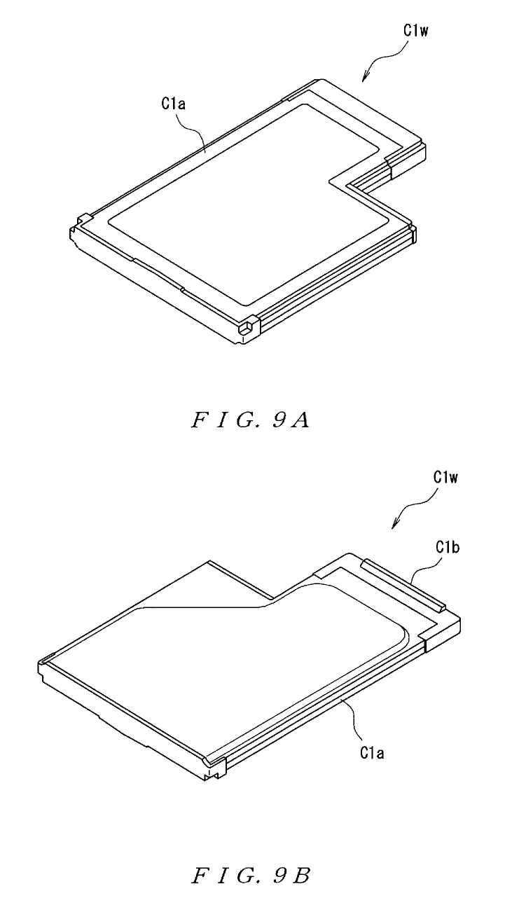

FIGS. 10A and 10B show another example of a first card (express card) that is inserted into and removed from the first card receiving slot, with FIG. 10A being a perspective view as seen from the side of the front surface, and FIG. 10B being a perspective view as seen from the side of the back surface;

FIGS. 11A and 11B show a conventional card connector that receives a PC card and a memory card of any of a plurality of types, with FIG. 11A being a front view, and FIG. 11B being a sectional view; and

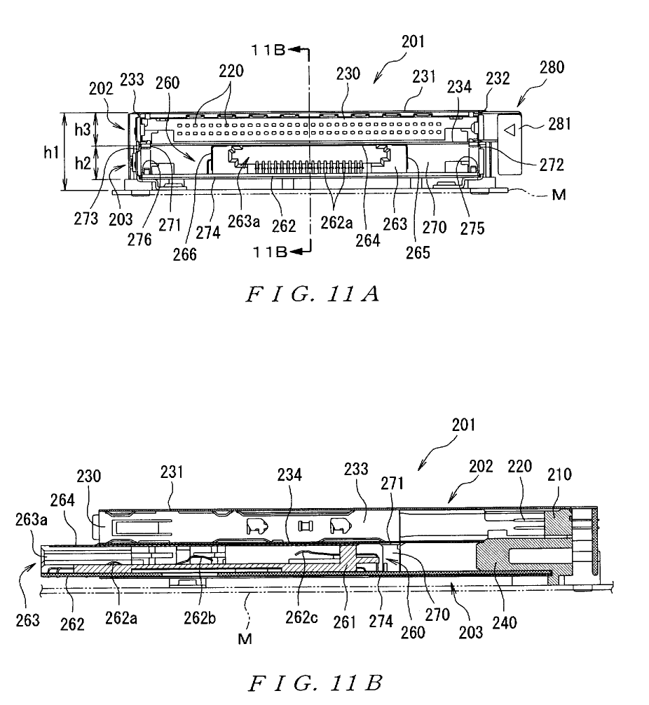

FIGS. 12A and 12B show an example of a second card that is inserted into and removed from the third card connector device, with FIG. 12A being a plan view as seen from the side of the front surface, and FIG. 12B being a back view as seen from the side of the back surface.

### DETAILED DESCRIPTION OF THE EMBODIMENT(S)

Next, an embodiment of the present invention will be described with reference to the figures.

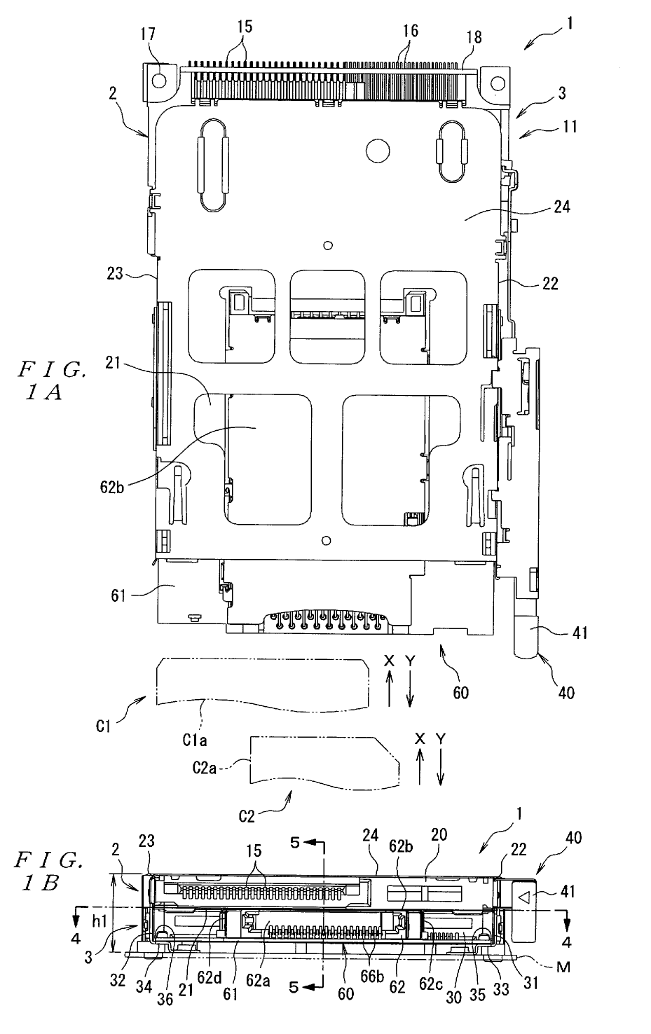

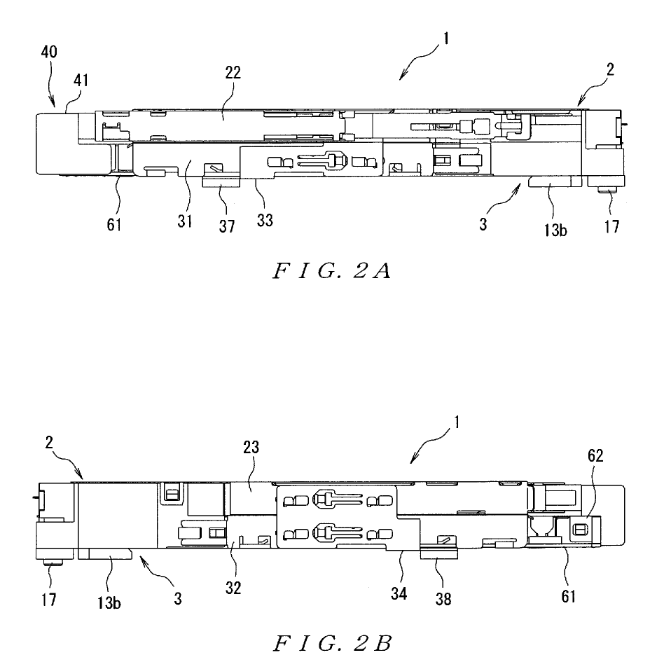

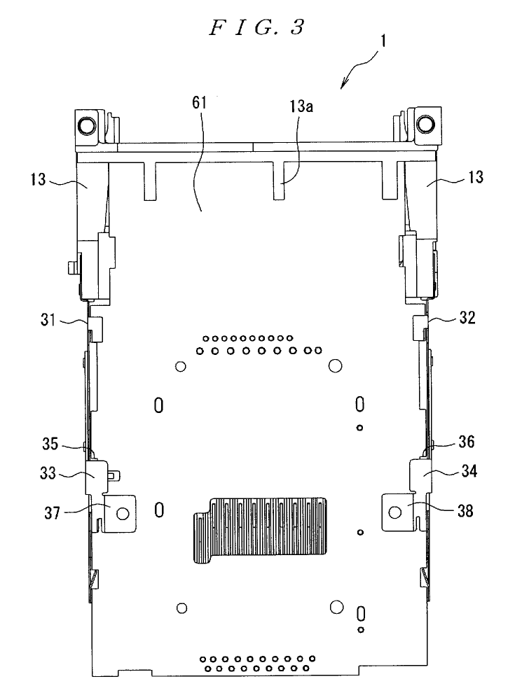

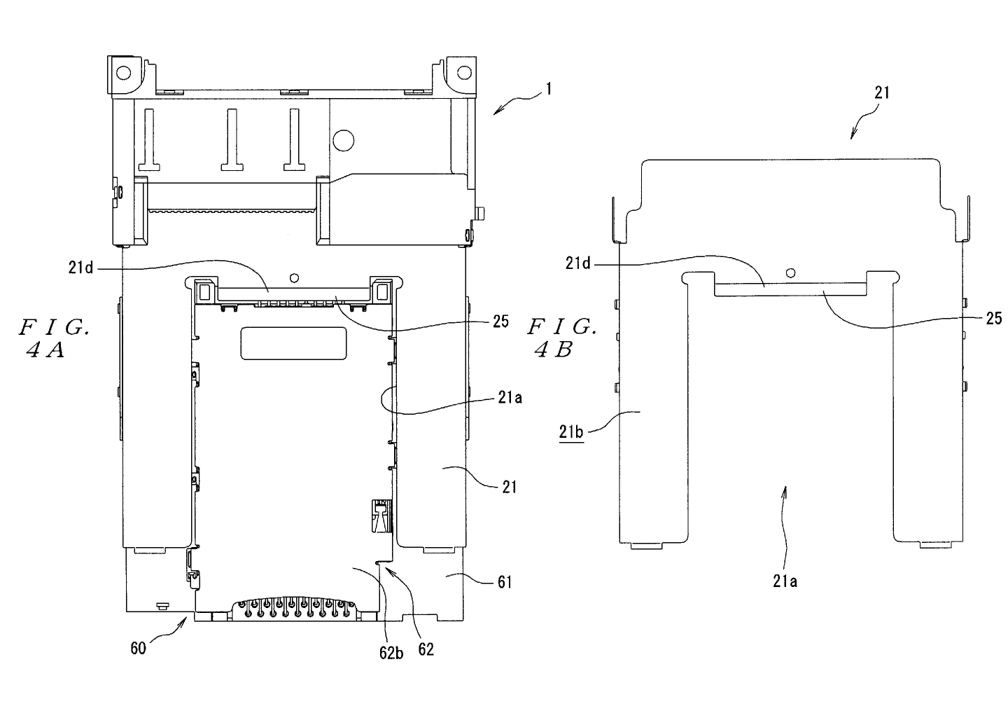

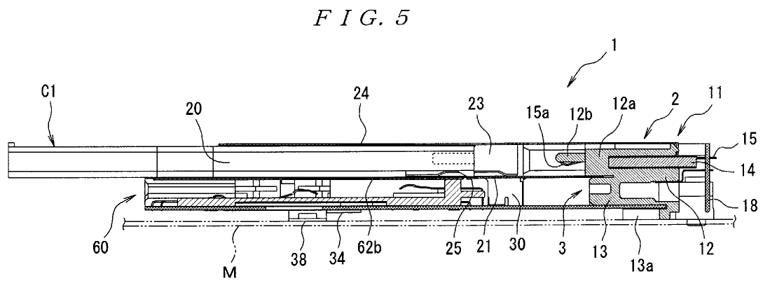

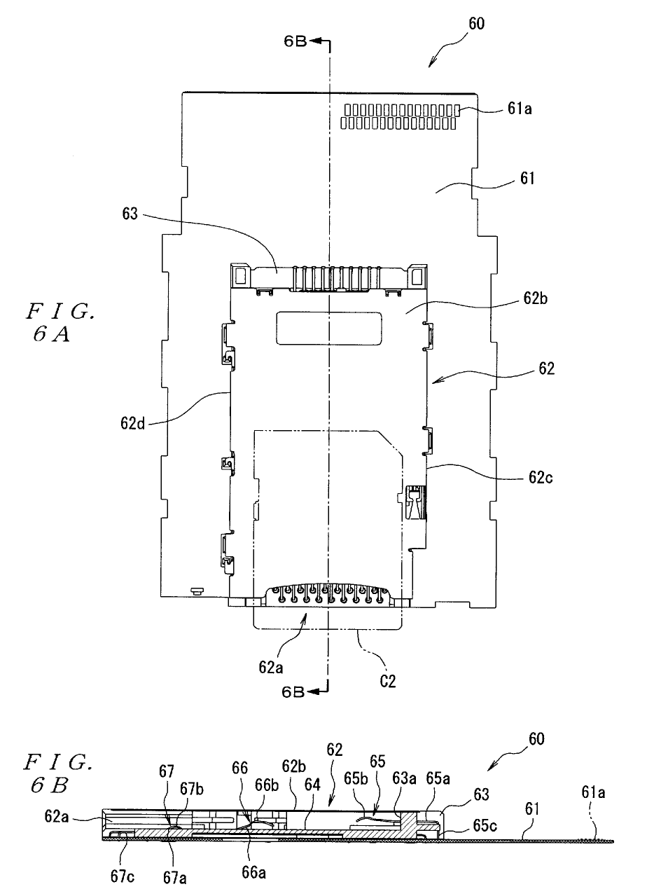

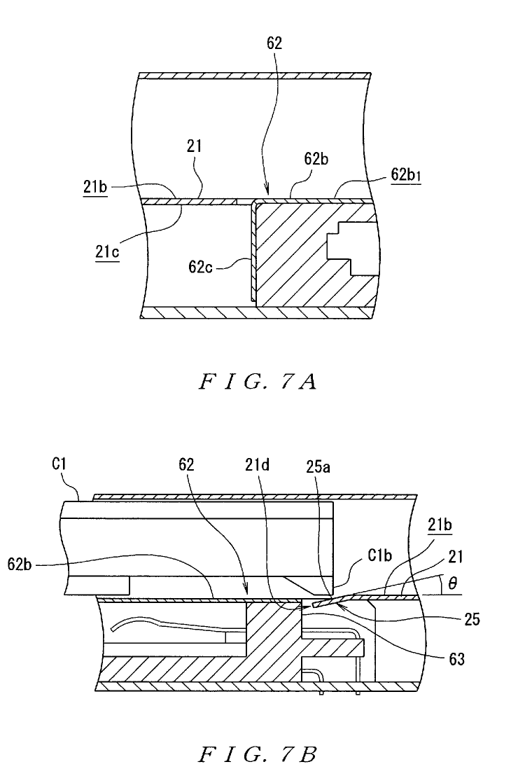

FIGS. 1A and 1B show a card connector according to the present invention; FIG. 1A is a plan view, and FIG. 1B is a front view. FIGS. 2A and 2B show the card connector of FIGS. 1A and 1B; FIG. 2A is a right side view, and FIG. 2B is a left side view. FIG. 3 is a bottom view of the card connector of FIGS. 1A and 1B. FIGS. 4A and 4B are the diagrams showing the construction of the partition frame; FIG. 4A is a sectional view along line 4-4 in FIG. 1B, and FIG. 4B is a plan view of the partition frame. FIG. 5 is a sectional view along line 5-5 in FIG. 1B. FIGS. 6A and 6B show the second card receiving unit; FIG. 6A is a plan view, and FIG. 6B is a sectional view along line 6B-6B in FIG. 6A. FIGS. 7A and 7B show the essential parts of the card connector of FIGS. 1A and 1B; FIG. 7A is a sectional view including the partition frame and top frame in FIG. 1B, and FIG. 7B is a sectional view showing the function of the inclined part during the insertion of the first card in FIG. 5.

In FIGS. 1A through 7B, the card connector 1 is formed by stacking a first card connector device 2 and a second card connector device 3.

The first card connector device 2 has an insulating first housing 12, a plurality of first contacts 15 attached to the first housing 12, and a first card receiving slot 20 that receives and guides an express card C1.

Furthermore, the second card connector device 3 has an insulating second housing 13 that is provided underneath the first housing 12, a plurality of second contacts 16 attached to the second housing 13, and a second card receiving slot 30 that guides a second card receiving unit 60 (not shown in the figures).

Incidentally, the first housing 12 and the second housing 13 provided underneath this first housing 12 may be formed integrally as a housing 11.

The first card receiving slot 20 is a receiving slot into which a first card C1 is inserted in the direction of arrow X in FIG. 1A and from which this card is removed in the direction of arrow Y.

The second card receiving slot 30 is a receiving slot that accommodates the second card receiving unit 60. Moreover, a second card C2 is inserted into the second card receiving unit 60 in the direction of arrow X in FIG. 1A and removed in the direction of arrow Y.

Here, the first card C1 is a card referred to as a so-called express card compliant with the PCMCIA standards as described previously, and includes an express card C1w with a wide width (a width of 54 mm) and an express card C1n formed with a narrow width (a width of 34 mm). Note that the connector parts (mating parts) of the express card C1w and express card C1n are both the same. Therefore, both the express card C1w and express card C1n can be inserted into and removed from the first card receiving slot 20. The forgoing description will involve a case in which the express card C1n is inserted and removed as the first card C1.

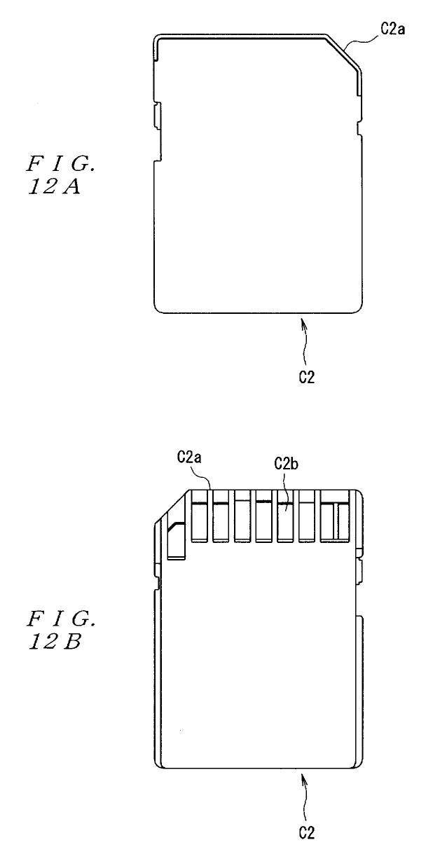

Moreover, the second card C2 is a memory card having card contact points provided on at least either the front surface or back surface thereof. For example, as is shown in FIGS. 12A and 12B, the second card C2 has a plurality of card contact points C2b provided on the back surface of the second card main body C2a. For examples, the second card C2 may include memory cards such as conventional SD (memory) cards, xD picture cards, multimedia cards (MMCs), and Memory Sticks (registered trademark).

The first card C1 inserted into the first card receiving slot 20 is connected to the first card connector device 2. The second card C2 inserted into the second card receiving unit 60 is connected to the second card connector device 3. Hereinafter, the direction of arrow X is referred to as the card insertion direction, the interior side in the card insertion direction is referred to as the front side, and the opposite side of this is referred to as the rear side. Furthermore, the direction of arrow Y is referred to as the card removal direction.

The first housing 12 is provided in a position corresponding to the first card receiving slot 20 in the vertical direction and to the front side of the first card receiving slot 20. Moreover, as is shown in FIG. 5, the first housing 12 includes an contact support 12a that accommodates a rectangular body 14 to which the plurality of first contacts 15 extending in the card insertion direction are attached. In addition, a projection 12b that protrudes rearward is formed on the contact support 12a.

Furthermore, each of the first contacts 15 has an resilient portion 15a that elastically contacts a card contact point (not shown in the figures) of the inserted first card C1 on the rear end the contact, and the front end is connected by soldering to a relay board 18. The resilient portion 15a is disposed so as to be exposed underneath the projection 12b.

Meanwhile, the second housing 13 is provided in a position corresponding to the second card receiving slot 30 in the vertical direction and to the front side of the second card receiving slot 30. The plurality of second contacts 16 (see FIG. 1A), extending in the card insertion direction, are attached to the second housing 13. The rear end portions of the individual second contacts 16 respectively contact conductive pads 61a (see FIG. 6A) formed on the circuit board 61 of the second card receiving unit 60, and the front end portions are connected by soldering to the relay board 18. Screw holes 17 for fastening the second housing 13 to the surface of a motherboard (not shown in the figures) are formed in this second housing 13.

As is shown in FIGS. 1A, 1B, 2A, 2B, and 5, the first card receiving slot 20 is formed from a top frame 24, a right side plate 22, a left side plate 23, and a partition frame 21. The top frame 24 and partition frame 21 are plate-form bodies that are attached to the first housing 12 and that extend rearward. The top frame 24, right side plate 22, and left side plate 23 are formed as an integral unit by bending downward both the right and left end portions of a single metal plate.

The lower end portions of the right side plate 22 and left side plate 23 are linked to the partition frame 21. The partition frame 21 supports the undersurface of the express card C1 upon insertion of this express card C1 into the first card receiving slot 20 until the removal of this card.

Furthermore, a first card ejection mechanism 40 is disposed on the external right side of the right side plate 22 of the first card receiving slot 20. The first card ejection mechanism 40 adopts a publicly known card ejection mechanism having a so-called push-push structure comprising a push button 41.

As is shown in FIGS. 1A, 1B, 2A, 2B, and 5, the second card receiving slot 30 is formed from the partition frame 21, a right side plate 31, a left side plate 32, lower supports 33 and 34, and upper supports 35 and 36. As was described above, the partition frame 21 is a plate-form body that is attached to the lower portion of the first housing 12 and that extends rearward. The partition frame 21 divides the first card receiving slot 20 and the second card receiving slot 30. The partition frame 21, right side plate 31, and left side plate 32 are formed as an integral unit by bending downward both the right and left end portions of a single metal plate. The lower supports 33 and 34 and upper supports 35 and 36 are provided on the right side plate 31 and left side plate 32. The lower support 33 is formed by bending the lower end portion of the right side plate 31 inward (leftward). The lower support 34 is formed by bending the lower end portion of the left side plate 32 inward (rightward). The lower supports 33 and 34 that are respectively bent inward are formed to face each other at a specified distance. The upper support 35 is a flat plate-form protruding piece that is positioned above the lower support 33 on the right side plate 31 and that is formed to protrude inward (leftward). The upper support 36 is a flat plate-form protruding piece that is positioned above the lower support 34 on the left side plate 32 and that is formed to protrude inward (rightward). Moreover, as in the lower supports 33 and 34, the upper supports 35 and 36 are also formed to face each other at a specified distance. Here, the distance between the lower support 33 and the upper support 35 and the distance between the lower support 34 and the upper support 36 are set at approximately the thickness of the circuit board 61. Therefore, the lower support 33 and upper support 35 and also the lower support 34 and upper support 36 respectively form pairs to support the circuit board 61. This is performed holding both end portions of this circuit board upon insertion of the second card receiving unit 60 into the second card receiving slot 30 until the removal of this second card receiving unit.

Thus, because the lower supports 33 and 34 and upper supports 35 and 36, which respectively face each other at a specified distance, are formed on the right side plate 31 and left side plate 32, a card connector having a minimum height dimension can be provided. The reason for this is as follows: namely, because the lower supports 33, 34 and upper supports 35, 36 only support the end portions of the circuit board on both sides (right and left edge portions), there is no need to take into consideration any clearance for covering the conductor pattern formed on the undersurface (back surface) of the circuit board.

In addition, as is shown in FIG. 3, fasteners 37 and 38 for fastening the right side plate 31 and left side plate 32 to the motherboard (not shown in the figures) are respectively provided on the right side plate 31 and left side plate 32.

The second card receiving unit 60 has the circuit board 61 and a third card connector device 62 that is mounted on this circuit board 61 as shown in FIGS. 6A and 6B.

The third card connector device 62 has a housing 63, third contacts 65, fourth contacts 66, and fifth contacts 67.

Furthermore, the third card connector device 62 includes an opening part (second card insertion slot) 62a that can receive a memory card (second card C2) of any of a plurality of types, a top frame 62b that restricts the upper surface of the second card C2 inserted from this opening 62a, and side frames 62c and 62d.

As is shown in FIGS. 6A and 6B, the housing 63 is formed in a rectangular shape by molding an insulating resin and is formed in a configuration in which the upper side and rear side are open leaving an end wall 63a. The end wall 63a positioned on the interior side in the direction of insertion of the second card C2 (forward), and the right and left side walls (not shown in the figures) are positioned on both ends of the housing 63 in the direction of width. The housing 63 includes a contact base 64 that is provided on the lower side in the card insertion direction and the opening 62a that is formed on the front side in the direction of insertion of the second card C2. An SD card, xD card, Memory Stick, or the like with a different width, thickness, and length can be inserted into the opening 62a.

Moreover, the plurality of third contacts 65 are attached to the end wall 63a of the housing 63 in a single row along the direction of width of this end wall 63a. Each of the third contacts 65 includes an mounting section 65a attached to the end wall 63a, a contact section 65b extending from the mounting section 65a toward the front in the direction of insertion of the second card C2, and a solder foot 65c extending from the mounting section 65a to the outside of the housing 63. The contact section 65b elastically deforms downward by being contacted from above this contact section 65b by a card contact point C2b (see FIGS. 12A and 12B) provided on the undersurface of the second card C2. The solder foot 65c is connected to a conductive pad 61a provided on the board 61 in the front end portion thereof, and is electrically continuous with a second contact 16 (see FIG. 1A) via this conductive pad 61a.

In addition, the plurality of fourth contacts 66 are attached to the central portion of the contact base 64 of the housing 63 in a single row along the direction of width of this contact base 64. Each of the fourth contacts 66 is formed by stamping and forming a metal plate. Each fourth contact 66 includes an mounting section 66a attached to the contact base 64, a contact section 66b extending from the mounting section 66a in the direction of insertion of the second card C2, and a board connecting part (not shown in the figures) extending from the mounting section 66a to the outside of the housing 63. The contact section 66b is positioned in the central portion of the housing 63 in the direction of insertion of the second card C2. The contact section 66b elastically deforms downward by being contacted from above this contact section 66b by a card contact point C2b (see FIGS. 12A and 12B) provided on the undersurface of the second card C2. The board connecting part (not shown in the figures) is also connected to a conductive pad 61a provided on the board 61 in the front end portion thereof, and is electrically continuous with a second contact 16 (see FIG. 1A) via this conductive pad 61a.

Furthermore, the plurality of fifth contacts 67 are attached to the rear of the contact base 64 of the housing 63 in a single row along the direction of width of this contact base 64. Each of the fifth contacts 67 comprises an mounting section 67a attached to the front end portion of the contact base 64, a contact section 67b extending from the mounting section 67a in the direction of insertion of the second card C2, and a solder foot 67c extending from the mounting section 67a to the outside of the housing 63. The contact section 67b is positioned toward the front of the housing 63 in the direction of insertion of the second card C2. Moreover, the contact section 67b elastically deforms downward by being contacted from above this contact section 67b by a card contact point C2b (see FIG. 12B) provided on the undersurface of the second card C2. The solder foot 67c is also connected to a conductive pad 61a provided on the board 61 in the front end portion thereof, and is electrically continuous with a second contact 16 (see FIG. 1A) via this conductive pad 61a.

Thus, the third contacts 65, fourth contacts 66, and fifth contacts 67 are disposed such that the contact sections 65b, contact sections 66b, and contact sections 67b respectively correspond to the various contact positions that are designed in accordance with the standards of the memory card (second card C2) of any of a plurality of types.

In addition, projecting parts (not shown in the figures) that restrict the entry of the second card main body C2a, in accordance with the standards of the second card C2 inserted into the opening 62a, are formed on the inner wall parts of the housing 63 in the vicinity of the front portions of the mounting sections 65a, 66a, and 67a. These projecting parts are provided in order to position either the third contacts 65, fourth contacts 66, or fifth contacts 67 with the corresponding card contact points C2b (see FIG. 12B) in accordance with the standards of the second card C2 inserted into the opening 62a.

The top frame 62b is a plate-form body that is attached to cover a part of the upper portion of the second housing 13 and that extends rearward.

Furthermore, the top frame 62b is positioned parallel to the circuit board 61 and provided above the third contacts 65, fourth contacts 66, and fifth contacts 67. The top frame 62b is a member that restricts the upper surface of the second card C2, which is pushed upward by the elastic forces of the third contacts 65, fourth contacts 66, or fifth contacts 67. Here, the upper surface of the second card C2 refers to the surface opposite the surface (undersurface) on which the card contact points C2b are pushed by the third contacts 65, fourth contacts 66, or fifth contacts 67 when the second card C2 is received in the third card connector device 62.

The side frames 62c and 62d are integrally formed by bending downward both the right and left end portions of the top frame 62b. The top frame 62b and side frames 62c and 62d are formed by forming a single metal plate. The side frames 62c and 62d are disposed to cover the housing 63, and both end portions thereof are fastened to the surface of the circuit board 61.

Note that the second card receiving unit 60 is accommodated in the second card receiving slot 30 in a detachable manner as a result of this second card receiving unit 60 being caused to slide forward in a state in which the circuit board 61 is held between the paired lower support 33 and upper support 35 and the paired lower support 34 and upper support 36 and also as a result of the undersurface of the circuit board 61 being supported by protruding parts 13a that protrude rearward in the lower end portion of the second housing 13 as shown in FIGS. 3 and 5.

Here, as is shown in FIGS. 4A, 4B and 5, a cutout 21a is formed in part of the rear end portion of the partition frame 21 based on the shape of the top frame 62b of the second card receiving unit 60. The shape of this cutout 21a can be appropriately selected as long as this cutout part is formed such that there is no interference with the support of the first card C1 by the partition frame 21 and such that at least a part of the top frame 62b fits inside the cutout 21a. Here, “at least a part of the top frame 62b fits inside the cutout 21a” refers to a configuration in which at least a part of the top frame 62b fits inside the cutout 21a in the direction of thickness of the top frame 62b. Moreover, for the shape of the cutout 21a, in a case in which the planar shape of the top frame 62b is rectangular, for example, a rectangle is selected to conform to this shape.

In addition, as is shown in FIG. 7A, the partition frame 21 is disposed such that the upper surface part 21b thereof is coplanar with the upper surface 62b₁ of the top frame 62b of the third card connector device 62, or disposed such that the upper surface 62b₁ of the top frame 62b is higher than the undersurface part 21c of the partition frame 21 and lower than the upper surface part 21b of the partition frame 21. Thus, the positional relationship between the upper surface 62b₁ of the top frame 62b and the upper surface part 21b and undersurface part 21c of the partition frame 21 is regulated by forming the cutout 21a in the partition frame 21 such that the upper surface 62b₁ of the top frame 62b fits this cutout 21a. Therefore, it is possible to provide a card connector that can prevent the express card C In from falling down and that can be replaced with a conventional card connector.

Here, in cases where the upper surface 62b₁ of the top frame 62b is located lower than the upper surface part 21b of the partition frame 21 due to variations over time or manufacturing error, the express card C In may be inserted slightly inclined to the lower right in the insertion direction in some instances. Even in such cases, as a result of the top frame 62b being provided as a part of the bottom frame in the first card receiving slot 20, the express card C1n can be guided forward without being caused to fall down.

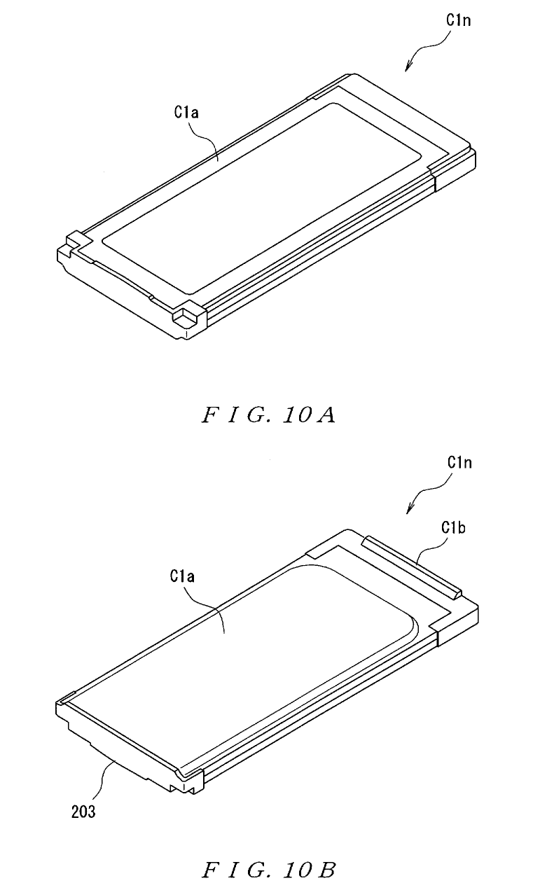

Furthermore, it is desirable that a lead in surface 25 having a sectional shape with the upper surface being inclined downward be formed on the end portion 21d of the partition frame 21 facing the direction of insertion of the first card C1 in the cutout 21a of the partition frame 21. Thus, by providing the lead in surface 25, the first card C1 can be guided smoothly without the flange part C1b (see FIG. 10B) of the first card C1 being caught when the first card C1 is inserted into the first card receiving slot 20. As is shown in FIGS. 5 and 7B, as the shape of such a lead in surface 25, a shape may be cited in which the end portion 21d of the partition frame 21 is caused to protrude rearward, and a portion of the end portion 21d is inclined at a specified angle of depression θ (specified angle of depression θ in the removal direction) with respect to the insertion direction using the upper surface part 21b of the partition frame 21 as a reference. Note that the angle of inclination θ of this lead in surface 25 is an angle that is appropriately set in a range in which there is no interference with receipt of the second card receiving unit 60 in the second card receiving slot 30. Moreover, the sectional shape of the upper surface (lead in surface 25a) of the lead in surface 25 may be a rectilinear shape or curved line shape as long as this is a shape with which the flange part C1b (see FIG. 10B) of the first card C1 is not caught.

Next, the function of the lead in surface 25 provided on the partition frame 21 will be described with reference to FIG. 7B. When the first card C1 is inserted into the first card receiving slot 20 as shown in FIG. 7B, the flange part C1b formed on the front end portion on the side of the back surface of the first card C1 passes through over the top frame 62b and then housing 63 of the third card connector device 62 while being supported by the partition frame 21. Afterward, the flange part C1b formed on the front end portion on the side of the back surface of the first card C1 passes through over the lead in surface 25 and is guided forward without being caught by the end portion 21d of the partition frame 21 in the direction of insertion of the first card C1.

Furthermore, when the first card C1 is removed from the first card receiving slot 20 as well, it is desirable that the front portion of the housing 63 have a rounded sectional shape. Thus, as a result of the front portion of the housing 63 having a rounded sectional shape, the flange part C1b passes through over the linked portion without colliding with the housing 63 when the first card C1 is removed from the first card receiving slot 20, so that the first card C1 can be removed without this card falling down.

An embodiment of the present invention has been described above. However, the present invention is not limited to this embodiment, and various alterations and modifications can be made.

For example, in the embodiment described above, the lead in surface 25 has a shape in which the end portion 21d of the partition frame 21 is caused to protrude rearward, and a portion of the end portion 21d is bent at a specified angle using the upper surface of the partition frame 21 as a reference. However, the sectional shape of the end portion 21d of the partition frame 21 may have a tapered shape based on the angle stipulated above.

Furthermore, projecting ribs having a rail shape that support the back surface of the first card may also be provided on the top frame 62b of the third card connector device 62 along the direction of insertion and removal of the first card.

What is claimed is:

1. A card connector comprising:
a first card receiving slot which receives a first card;
a second card receiving slot that accommodates a second card receiving unit that receives a second card having different standards from the first card; the second card receiving unit having a top frame which restricts an upper surface of the second card that is pushed upward by contacts;
a partition frame dividing the first card receiving slot and the second card receiving slot, the partition frame supporting a lower portion of the first card;
a cutout formed in the partition frame, wherein at least a portion of the top frame fits in the cutout; and
the upper surface part of the top frame being at least partially disposed between an upper surface part of the partition frame and a lower surface part of the partition frame.

2. The card connector according to claim 1, wherein a lead in surface having a sectional shape which is such that the upper surface forms an angle of depression with respect to the direction of insertion of the first card is provided on the end of the partition frame facing the insertion direction in the cutout.

3. The card connector according to claim 1, wherein the second card receiving unit is formed from a third card connector device that receives the second card and a circuit board on which the third card connector device is mounted.

4. The card connector according to claim 3, wherein supporting parts that support the circuit board by respectively holding end portions on both sides of this circuit board are respectively formed on both side surfaces of the second card receiving slot facing each other at a specified distance.

5. The card connector according to claim 1, further comprising a first housing and a second housing provided underneath the first housing.

6. The card connector according to claim 5, wherein the partition frame is a plate-form body that is attached to the lower portion of the first housing and extends rearward.

7. The card connector according to claim 5, wherein the first housing and the second housing are formed integrally as a single housing.

8. The card connector according to claim 5, wherein the partition frame is a plate-form body that is attached to the lower portion of the first housing and that extends rearward.

9. The card connector according to claim 1, wherein the first card is an express card compliant with the PCMCIA standards.

10. The card connector according to claim 1, wherein the second card is a memory card having card contact points.

11. The card connector according to claim 1, further comprising a first card ejection mechanism.

12. The card connector according to claim 11, wherein the first card ejection mechanism is disposed on an external side of a side plate of the first card receiving slot.

13. The card connector according to claim 12, wherein the first card ejection mechanism is a push-push structure comprising a push button.

14. The card connector according to claim 1, wherein the second card receiving slot is formed from the partition frame, a right side plate, a left side plate, lower supports and upper supports.

15. The card connector according to claim 14, wherein the partition frame, right side plate, and left side plate are formed as an integral unit by bending downward both right and left end portions of a single metal plate.

16. The card connector according to claim 1, wherein the shape of the cutout can be appropriately selected so that the cutout is formed such that there is no interference with the support of the first card by the partition frame and such that at least a part of the top frame fits inside the cutout.

17. The card connector according to claim 2, wherein the lead in surface having an upper surface is formed on an end portion of the partition frame facing the direction of insertion of the first card in the cutout of the partition frame.

18. The card connector according to claim 17, wherein the upper surface of the lead in surface is inclined downward.

19. The card connector according to claim 17, the lead in surface has a shape in which the end portion of the partition frame is caused to protrude rearward, and a portion of the end portion is bent at a specified angle using the upper surface of the partition frame as a reference.
